(19) United States
(12) Patent Application Publication
(10) Pub. No.: US 2014/0089981 A1
(43) Pub. Date: Mar. 27, 2014

(54) SYSTEMS AND METHODS FOR PRESENTING SHORTCUTS IN FREE SPACES OF A PROGRAM GUIDE

(71) Applicants: Camron Shimy, Canyon Country, CA (US); Jason Conness, Pasadena, CA (US)

(72) Inventors: Camron Shimy, Canyon Country, CA (US); Jason Conness, Pasadena, CA (US)

(73) Assignee: UNITED VIDEO PROPERTIES, INC., Santa Clara, CA (US)

(21) Appl. No.: 13/626,837

(22) Filed: Sep. 25, 2012

(51) Int. Cl. H04N 21/431

(52) U.S. Cl. 725/46; 725/44

(57) ABSTRACT

Systems and methods for presenting shortcuts in free spaces of a program guide are provided. Shortcut buttons may be placed in certain program information cells in the program guide. In some embodiments, these placements may be determined by making automatic determinations using characteristics or data associated with the program information cells. In one example, a subset of the program information cells that are bounded by an end time not displayed in the time bar of the first screen of the program guide are automatically determined. Shortcut button may be placed within these program information cells that, when selected, cause the media guidance application to automatically advance or translate the rendering of the program grid to a portion of the guide that contains listings for the channel associated with the program information cells after they end (e.g., finish broadcast or are available on demand).

### BACKGROUND OF THE INVENTION

Program guides often have free or open spaces in their display. For example, program guides that are in a grid format, e.g., with time information on a horizontal axis and channel information on a vertical axis, have program information cells that represent particular programs available for a user to view. If these programs are of a particular length, a corresponding program information cell may extend beyond a single screen of the program grid. Since a limited amount of information may be displayed inside these longer program information cells (i.e., a program title, parental rating, and/or brief synopsis), they may contain large amounts of free space. While the invention is described in the context of program listings or cells, the invention may be applied to any type of display that includes listings for media assets such as, for example, a playlist arrangement.

In addition, these longer program cells may be tedious to navigate through. For example, if a user is accessing a display of a program guide on a tablet computing device, the user may have to execute multiple gestures, such as swipes or flicks of their finger on the screen, in order to advance the program guide to program information cells associated with programs that are available for viewing after a long program. These multiple gestures may be tedious, physically demanding, time intensive, and/or computing resource intensive. Accordingly, there is a need to display and allow the user to access shortcut buttons or other visual indicators within longer program information cells.

### SUMMARY OF THE INVENTION

Systems and methods are described herein for navigating media guidance information in a program guide. In one embodiment, a first screen of a program guide is displayed. This first screen may include a time bar divided into time cells arranged along a first axis, each representing an interval of time, as well as a content source identifier divided into channel cells arranged along a second axis. A program grid is displayed that has program information cells for presenting information associated with media assets in the channel cells and time cells. Each program information cell is bounded by a start time and an end time. Because this first screen may contain a limited amount of space, not all of the program information cells are displayed. Accordingly, only program information cells associated with a subset of the channel cells and time cells may be displayed in a single screen. Further, some program information cells in the first screen may be bounded by an end time that is not displayed in the time bar. These program information cells may be rendered in the display such that they have an excess of free space.

Shortcut buttons may be placed in (i.e., rendered within the display of) certain program information cells. In some embodiments, these placements may be determined by making automatic determinations using characteristics or data associated with the program information cells. In one example, a subset of the program information cells that are bounded by an end time not displayed in the time bar of the first screen of the program guide are automatically determined. A shortcut button may be placed within these program information cells that, when selected, automatically advance the program grid to a portion of the guide that contains listings for the channel associated with the program information cells after they end (e.g., finish broadcast or are available on demand). In the context of the invention, buttons are any visual indicator (i.e., visual element in the graphical user interface) that the user can interact with. In one example, if the program grid is presented on a tablet computer that has a touch screen, buttons may be presented as squares within program information cells in the grid that a user can navigate to and select using one or more touch gestures on the touch screen. In another example, if the program grid is presented on a conventional television, the buttons may be presented as squares within the program information cells in the grid that the user can navigate to and select using one or more presses of keys on a remote control. In this manner, the user can quickly and easily navigate past a long program cell to subsequent program listings on a channel.

In certain embodiments, information may be retrieved that is associated with the cells. This information may include program title, program start time, program duration, user rating, parental guidance rating, genre, actor information, director information, or presentation quality (i.e., standard definition or high definition), or any suitable information. This information may then be displayed within the shortcut buttons.

In another example, a program information cell is automatically determined that is associated with standard definition content and has a high-definition counterpart. Another program information cell is automatically determined that is associated with the high-definition counterpart. In other words, the program that is associated with the program information cell is presented in standard definition on a first channel, and there is a concurrent or subsequent presentation of that program on a second channel that is presented in high-definition. Shortcut buttons may be placed within the program information cell associated with standard-definition content that, when selected, automatically translates the program grid to a portion of the guide containing a program information cell associated with the high-definition counterpart. In this manner, a user can quickly and easily navigate to a listing of a high-definition presentation of a program from a listing of a standard-definition presentation of a program.

In another example, a first program information cell is automatically determined that is associated with a sporting event featuring a particular sports team. Another program information cell is automatically determined that is associated with a subsequent sporting event featuring the particular sports team. Shortcut buttons may be placed within the first program information cell that, when selected, automatically translate the program grid to a portion of the guide containing the other program information cell. In such a manner, a user can quickly and easily navigate from a listing associated with a first sporting event to a listing associated with a subsequent sporting event related to the same team, from which the user can record or set a reminder associated with the subsequent sporting event for later viewing.

In yet another example, a first program information cell is automatically determined that is associated with an episode of a series program. A second program information cell is automatically determined that is associated with a subsequent episode of the series program. Shortcut buttons may be placed within the first program information cell that, when selected, automatically translate the program grid to a portion of the guide containing the second program information cell. In such a manner, a user can quickly and easily navigate from a listing associated with a first episode of a series program to a listing associated with a second episode of the same series, from which the user can record or set a reminder associated with the subsequent episode for later viewing.

In certain embodiments, user profile information may be accessed that indicates the frequency of shortcut button placement desired by a user. Based on this frequency, the display of shortcut buttons may be limited in the guide.

### BRIEF DESCRIPTION OF THE DRAWINGS

The above and other objects and advantages of the invention will be apparent upon consideration of the following detailed description, taken in conjunction with the accompanying drawings, in which like reference characters refer to like parts throughout, and in which:

FIG. 1 shows an illustrative interactive media guidance application display screen in accordance with some embodiments of the present disclosure;

FIG. 2 shows another illustrative interactive media guidance application display screen in accordance with some embodiments of the present disclosure;

FIG. 3 illustrates an example of a user equipment device in accordance with some embodiments of the present disclosure;

FIG. 4 illustrates an example of a cross-platform interactive media system in accordance with some embodiments of the present disclosure;

FIGS. 5A, 5B, 6A, 6B, 7A, and 7B show illustrative interactive media guidance application screens demonstrating the functionality of shortcut buttons in accordance with some embodiments of the present disclosure;

FIG. 8 shows an illustrative data structure associated with a program information cell in a program grid in accordance with some embodiments of the present disclosure;

FIG. 9 shows an illustrative flowchart for presenting shortcuts in free spaces of a program guide in accordance with some embodiments of the present disclosure;

FIG. 10 shows an illustrative flowchart for presenting shortcuts in free spaces of a program guide in accordance with some embodiments of the present disclosure; and

FIG. 11 shows yet another illustrative flowchart for presenting shortcuts in free spaces of a program guide in accordance with some embodiments of the present disclosure.

### DETAILED DESCRIPTION OF EMBODIMENTS

The amount of content available to users in any given content delivery system can be substantial. Consequently, many users desire a form of media guidance through an interface that allows users to efficiently navigate content selections and easily identify content that they may desire. An application that provides such guidance is referred to herein as an interactive media guidance application or, sometimes, a media guidance application or a guidance application.

Interactive media guidance applications may take various forms depending on the content for which they provide guidance. One typical type of media guidance application is an interactive television program guide. Interactive television program guides (sometimes referred to as electronic program guides) are well-known guidance applications that, among other things, allow users to navigate among and locate many types of content or media assets. Interactive media guidance applications may generate graphical user interface screens that enable a user to navigate among, locate and select content. As referred to herein, the terms “media asset” and “content” should be understood to mean an electronically consumable user asset, such as television programming, as well as pay-per-view programs, on-demand programs (as in video-on-demand (VOD) systems), Internet content (e.g., streaming content, downloadable content, Webcasts, etc.), video clips, audio, content information, pictures, rotating images, documents, playlists, websites, articles, books, electronic books, blogs, advertisements, chat sessions, social media, applications, games, and/or any other media or multimedia and/or combination of the same. Guidance applications also allow users to navigate among and locate content. As referred to herein, the term “multimedia” should be understood to mean content that utilizes at least two different content forms described above, for example, text, audio, images, video, or interactivity content forms. Content may be recorded, played, displayed or accessed by user equipment devices, but can also be part of a live performance.

With the advent of the Internet, mobile computing, and high-speed wireless networks, users are accessing media on user equipment devices on which they traditionally did not. As referred to herein, the phrase “user equipment device,” “user equipment,” “user device,” “electronic device,” “electronic equipment,” “media equipment device,” or “media device” should be understood to mean any device for accessing the content described above, such as a television, a Smart TV, a set-top box, an integrated receiver decoder (IRD) for handling satellite television, a digital storage device, a digital media receiver (DMR), a digital media adapter (DMA), a streaming media device, a DVD player, a DVD recorder, a connected DVD, a local media server, a BLU-RAY player, a BLU-RAY recorder, a personal computer (PC), a laptop computer, a tablet computer, a WebTV box, a personal computer television (PC/TV), a PC media server, a PC media center, a hand-held computer, a stationary telephone, a personal digital assistant (PDA), a mobile telephone, a portable video player, a portable music player, a portable gaming machine, a smart phone, or any other television equipment, computing equipment, or wireless device, and/or combination of the same. In some embodiments, the user equipment device may have a front facing screen and a rear facing screen, multiple front screens, or multiple angled screens. In some embodiments, the user equipment device may have a front facing camera and/or a rear facing camera. On these user equipment devices, users may be able to navigate among and locate the same content available through a television. Consequently, media guidance may be available on these devices, as well. The guidance provided may be for content available only through a television, for content available only through one or more of other types of user equipment devices, or for content available both through a television and one or more of the other types of user equipment devices. The media guidance applications may be provided as on-line applications (i.e., provided on a website), or as stand-alone applications or clients on user equipment devices. Various devices and platforms that may implement media guidance applications are described in more detail below.

One of the functions of the media guidance application is to provide media guidance data to users. As referred to herein, the phrase, “media guidance data” or “guidance data” should be understood to mean any data related to content, such as media listings, media-related information (e.g., broadcast times, broadcast channels, titles, descriptions, ratings information (e.g., parental control ratings, critic's ratings, etc.), genre or category information, actor information, logo data for broadcasters' or providers' logos, etc.), media format (e.g., standard definition, high definition, 3D, etc.), advertisement information (e.g., text, images, media clips, etc.), on-demand information, blogs, websites, and any other type of guidance data that is helpful for a user to navigate among and locate desired content selections.

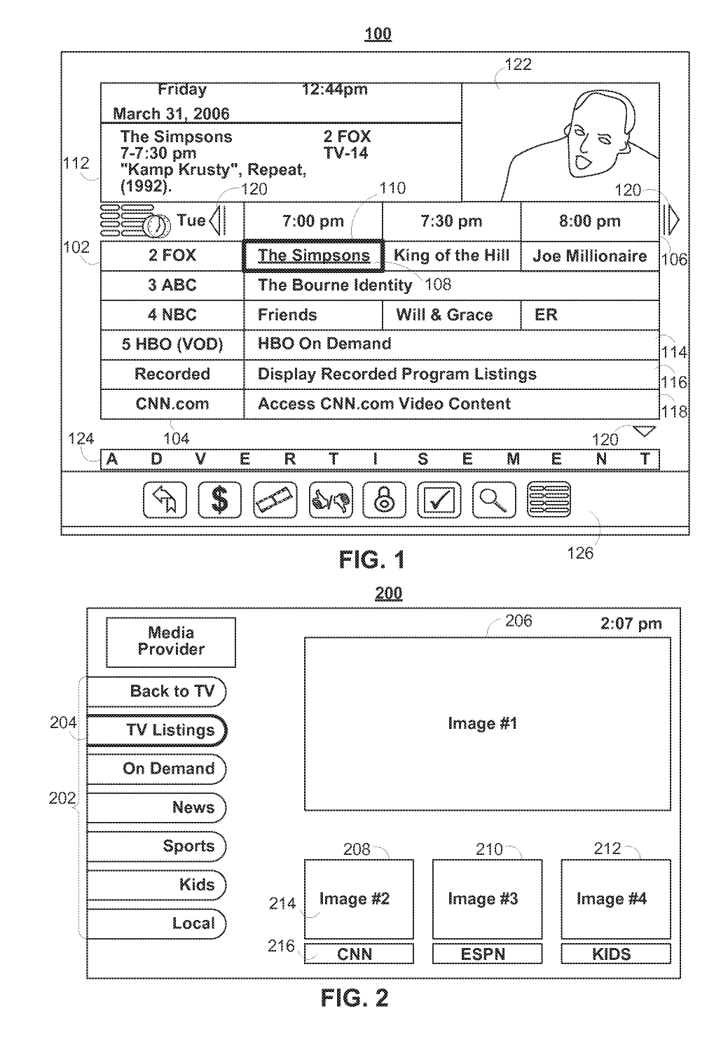

FIGS. 1-2 show illustrative display screens that may be used to provide media guidance data. The display screens shown in FIGS. 1-2, 5A, 5B, 6A, 6B, 7A, and 7B may be implemented on any suitable user equipment device or platform. While the displays of FIGS. 1-2, 5A, 5B, 6A, 6B, 7A, and 7B are illustrated as full screen displays, they may also be fully or partially overlaid over content being displayed. A user may indicate a desire to access content information by selecting a selectable option provided in a display screen (e.g., a menu option, a listings option, an icon, a hyperlink, etc.) or pressing a dedicated button (e.g., a GUIDE button) on a remote control or other user input interface or device. In response to the user's indication, the media guidance application may provide a display screen with media guidance data organized in one of several ways, such as by time and channel in a grid, by time, by channel, by source, by content type, by category (e.g., movies, sports, news, children, or other categories of programming), or other predefined, user-defined, or other organization criteria. The organization of the media guidance data is determined by guidance application data. As referred to herein, the phrase, “guidance application data” should be understood to mean data used in operating the guidance application, such as program information, guidance application settings, user preferences, or user profile information.

FIG. 1 shows illustrative grid program listings display 100 arranged by time and channel that also enables access to different types of content in a single display. Display 100 may include grid 102 with: (1) a column of channel/content type identifiers 104 along a vertical axis, where each channel/content type identifier (which is a cell in the column) identifies a different channel or content type available; and (2) a row of time identifiers 106 along a horizontal axis, where each time identifier (which is a cell in the row) identifies a time block of programming. As illustrated, the column of channel/content identifiers 104 and time identifiers 106 may be perpendicular to each other. In other embodiments the column of channel/content identifiers 104 and time identifiers 106 may be displayed in an arrangement other than a grid. For example, a single column of channel/content identifiers 104 or a single column of time identifiers 106 may be displayed. The column of channel/content type identifiers 104 may be collectively referred to as a content source identifier, while the row time identifiers 106 may be referred to collectively as a time bar. In certain embodiments, each cell in the time bar may represent a fixed interval of time along its respective width, such as fifteen minutes, thirty minutes, one hour, or any suitable amount of time. Grid 102 also includes cells of program listings (referred to herein as “program information cells”), such as program listing 108, where each listing provides the title of the program provided on the listing's associated channel and time. With a user input device, a user can select program listings by moving highlight region 110. Information relating to the program listing selected by highlight region 110 may be provided in program information region 112. Region 112 may include, for example, the program title, the program description, the time the program is provided (if applicable), the channel the program is on (if applicable), the program's rating, and other desired information.

In addition to providing access to linear programming (e.g., content that is scheduled to be transmitted to a plurality of user equipment devices at a predetermined time and is provided according to a schedule), the media guidance application also provides access to non-linear programming (e.g., content accessible to a user equipment device at any time and is not provided according to a schedule). Non-linear programming may include content from different content sources including on-demand content (e.g., VOD), Internet content (e.g., streaming media, downloadable media, etc.), locally stored content (e.g., content stored on any user equipment device described above or other storage device), or other time-independent content. On-demand content may include movies or any other content provided by a particular content provider (e.g., HBO On Demand providing “The Sopranos” and “Curb Your Enthusiasm”). HBO ON DEMAND is a service mark owned by Time Warner Company L. P. et al. and THE SOPRANOS and CURB YOUR ENTHUSIASM are trademarks owned by the Home Box Office, Inc. Internet content may include web events, such as a chat session or Webcast, or content available on-demand as streaming content or downloadable content through an Internet website or other Internet access (e.g. FTP).

Grid 102 may provide media guidance data for non-linear programming including on-demand listing 114, recorded content listing 116, and Internet content listing 118. A display combining media guidance data for content from different types of content sources is sometimes referred to as a “mixed-media” display. Various permutations of the types of media guidance data that may be displayed that are different than display 100 may be based on user selection or guidance application definition (e.g., a display of only recorded and broadcast listings, only on-demand and broadcast listings, etc.). As illustrated, listings 114, 116, and 118 are shown as spanning the entire time block displayed in grid 102 to indicate that selection of these listings may provide access to a display dedicated to on-demand listings, recorded listings, or Internet listings, respectively. In some embodiments, listings for these content types may be included directly in grid 102. Additional media guidance data may be displayed in response to the user selecting one of the navigational icons 120. (Pressing an arrow key on a user input device may affect the display in a similar manner as selecting navigational icons 120.)

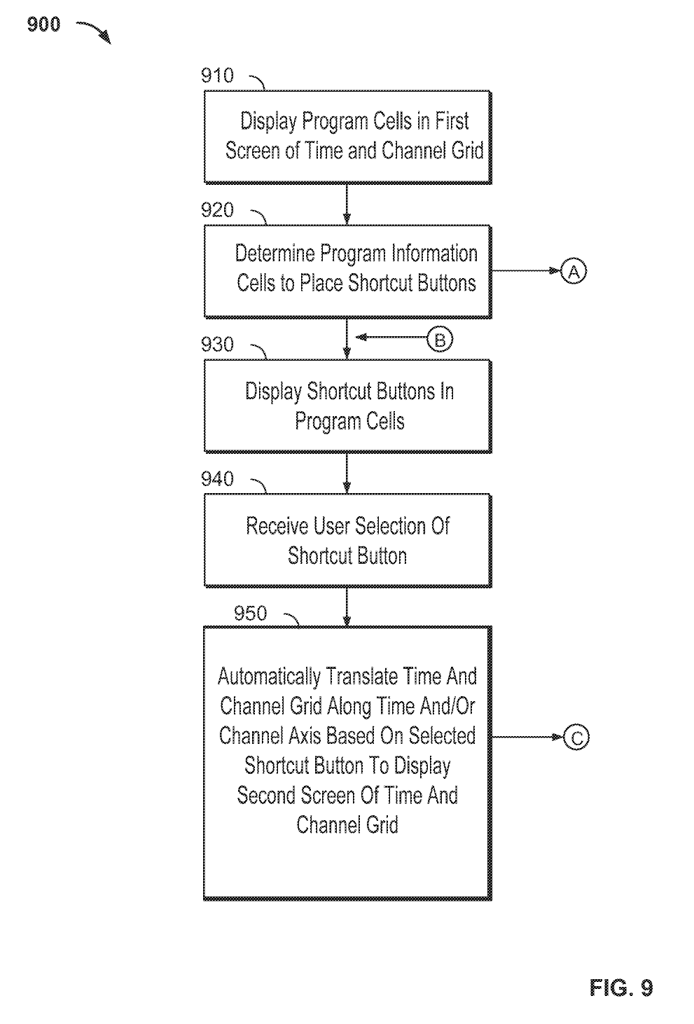

Display 100 may also include video region 122, advertisement 124, and options region 126. Video region 122 may allow the user to view and/or preview programs or user-generated content that is currently available, will be available, or were available to the user. The content of video region 122 may correspond to, or be independent from, one of the listings displayed in grid 102, or one of the selected groupings of display 900 (discussed below with respect to FIG. 9). Grid displays including a video region are sometimes referred to as picture-in-guide (PIG) displays. PIG displays and their functionalities are described in greater detail in Satterfield et al. U.S. Pat. No. 6,564,378, issued May 13, 2003 and Yuen et al. U.S. Pat. No. 6,239,794, issued May 29, 2001, which are hereby incorporated by reference herein in their entireties. PIG displays may be included in other media guidance application display screens of the embodiments described herein.

Advertisement 124 may provide an advertisement for content that, depending on a viewer's access rights (e.g., for subscription programming), is currently available for viewing, will be available for viewing in the future, or may never become available for viewing, and may correspond to or be unrelated to one or more of the content listings in grid 102. Advertisement 124 may also be for products or services related or unrelated to the content displayed in grid 102. Advertisement 124 may be selectable and provide further information about content, provide information about a product or a service, enable purchasing of content, a product, or a service, provide content relating to the advertisement, etc. Advertisement 124 may be targeted based on a user's profile/preferences, monitored user activity, the type of display provided, or on other suitable targeted advertisement bases.

While advertisement 124 is shown as rectangular or banner shaped, advertisements may be provided in any suitable size, shape, and location in a guidance application display. For example, advertisement 124 may be provided as a rectangular shape that is horizontally adjacent to grid 102. This is sometimes referred to as a panel advertisement. In addition, advertisements may be overlaid over content or a guidance application display or embedded within a display. Advertisements may also include text, images, rotating images, video clips, or other types of content described above. Advertisements may be stored in a user equipment device having a guidance application, in a database connected to the user equipment, in a remote location (including streaming media servers), or on other storage means, or a combination of these locations. Providing advertisements in a media guidance application is discussed in greater detail in, for example, Knudson et al., U.S. Patent Application Publication No. 2003/0110499, filed Jan. 17, 2003; Ward, III et al. U.S. Pat. No. 6,756,997, issued Jun. 29, 2004; and Schein et al. U.S. Pat. No. 6,388,714, issued May 14, 2002, which are hereby incorporated by reference herein in their entireties. It will be appreciated that advertisements may be included in other media guidance application display screens of the embodiments described herein.

Options region 126 may allow the user to access different types of content, media guidance application displays, and/or media guidance application features. Options region 126 may be part of display 100 (and other display screens described herein), or may be invoked by a user by selecting an on-screen option or pressing a dedicated or assignable button on a user input device. The selectable options within options region 126 may concern features related to program listings in grid 102 or may include options available from a main menu display. Features related to program listings may include searching for other air times or ways of receiving a program, recording a program, enabling series recording of a program, setting program and/or channel as a favorite, purchasing a program, or other features. Options available from a main menu display may include search options, VOD options, parental control options, Internet options, cloud-based options, device synchronization options, second screen device options, options to access various types of media guidance data displays, options to subscribe to a premium service, options to edit a user's profile, options to access a browse overlay, or other options.

The media guidance application may be personalized based on a user's preferences. A personalized media guidance application allows a user to customize displays and features to create a personalized “experience” with the media guidance application. This personalized experience may be created by allowing a user to input these customizations and/or by the media guidance application monitoring user activity to determine various user preferences. Users may access their personalized guidance application by logging in or otherwise identifying themselves to the guidance application. Customization of the media guidance application may be made in accordance with a user profile. The customizations may include varying presentation schemes (e.g., color scheme of displays, font size of text, etc.), aspects of content listings displayed (e.g., only HDTV or only 3D programming, user-specified broadcast channels based on favorite channel selections, re-ordering the display of channels, recommended content, etc.), desired recording features (e.g., recording or series recordings for particular users, recording quality, etc.), parental control settings, customized presentation of Internet content (e.g., presentation of social media content, e-mail, electronically delivered articles, etc.) and other desired customizations.

The media guidance application may allow a user to provide user profile information or may automatically compile user profile information. The media guidance application may, for example, monitor the content the user accesses and/or other interactions the user may have with the guidance application. Additionally, the media guidance application may obtain all or part of other user profiles that are related to a particular user (e.g., from other websites on the Internet the user accesses, such as www.allrovi.com, from other media guidance applications the user accesses, from other interactive applications the user accesses, from another user equipment device of the user, etc.), and/or obtain information about the user from other sources that the media guidance application may access. As a result, a user can be provided with a unified guidance application experience across the user's different user equipment devices. This type of user experience is described in greater detail below in connection with FIG. 4. Additional personalized media guidance application features are described in greater detail in Ellis et al., U.S. Patent Application Publication No. 2005/0251827, filed Jul. 11, 2005, Boyer et al., U.S. Pat. No. 7,165,098, issued Jan. 16, 2007, and Ellis et al., U.S. Patent Application Publication No. 2002/0174430, filed Feb. 21, 2002, which are hereby incorporated by reference herein in their entireties.

Another display arrangement for providing media guidance is shown in FIG. 2. Video mosaic display 200 includes selectable options 202 for content information organized based on content type, genre, and/or other organization criteria. In display 200, television listings option 204 is selected, thus providing listings 206, 208, 210, and 212 as broadcast program listings. In display 200 the listings may provide graphical images including cover art, still images from the content, video clip previews, live video from the content, or other types of content that indicate to a user the content being described by the media guidance data in the listing. Each of the graphical listings may also be accompanied by text to provide further information about the content associated with the listing. For example, listing 208 may include more than one portion, including media portion 214 and text portion 216. Media portion 214 and/or text portion 216 may be selectable to view content in full-screen or to view information related to the content displayed in media portion 214 (e.g., to view listings for the channel that the video is displayed on).

The listings in display 200 are of different sizes (i.e., listing 206 is larger than listings 208, 210, and 212), but if desired, all the listings may be the same size. Listings may be of different sizes or graphically accentuated to indicate degrees of interest to the user or to emphasize certain content, as desired by the content provider or based on user preferences. Various systems and methods for graphically accentuating content listings are discussed in, for example, Yates, U.S. Patent Application Publication No. 2010/0153885, filed Dec. 29, 2005, which is hereby incorporated by reference herein in its entirety.

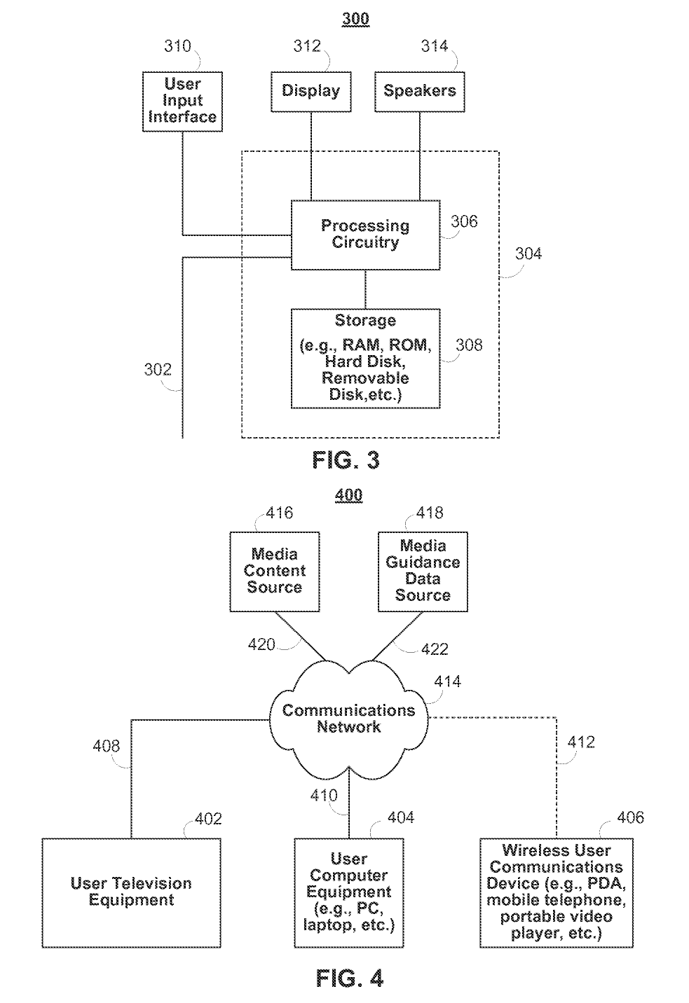

Users may access content and the media guidance application (and its display screens described above and below) from one or more of their user equipment devices. FIG. 3 shows a generalized embodiment of illustrative user equipment device 300. More specific implementations of user equipment devices are discussed below in connection with FIG. 4. User equipment device 300 may receive content and data via input/output (hereinafter “I/O”) path 302. I/O path 302 may provide content (e.g., broadcast programming, on-demand programming, Internet content, content available over a local area network (LAN) or wide area network (WAN), and/or other content) and data to control circuitry 304, which includes processing circuitry 306 and storage 308. Control circuitry 304 may be used to send and receive commands, requests, and other suitable data using I/O path 302. I/O path 302 may connect control circuitry 304 (and specifically processing circuitry 306) to one or more communications paths (described below). I/O functions may be provided by one or more of these communications paths, but are shown as a single path in FIG. 3 to avoid overcomplicating the drawing.

Control circuitry 304 may be based on any suitable processing circuitry such as processing circuitry 306. As referred to herein, processing circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, processing circuitry may be distributed across multiple separate processors or processing units, for example, multiples of the same type of processing units (e.g., two Intel Core i7 processors) or multiple different processors (e.g., an Intel Core i5 processor and an Intel Core i7 processor). In some embodiments, control circuitry 304 executes instructions for a media guidance application stored in memory (i.e., storage 308). Specifically, control circuitry 304 may be instructed by the media guidance application to perform the functions discussed above and below. For example, the media guidance application may provide instructions to control circuitry 304 to generate the media guidance displays. In some implementations, any action performed by control circuitry 304 may be based on instructions received from the media guidance application.

In client-server based embodiments, control circuitry 304 may include communications circuitry suitable for communicating with a guidance application server or other networks or servers. The instructions for carrying out the above-mentioned functionality may be stored on the guidance application server. Communications circuitry may include a cable modem, an integrated services digital network (ISDN) modem, a digital subscriber line (DSL) modem, a telephone modem, Ethernet card, or a wireless modem for communications with other equipment, or any other suitable communications circuitry. Such communications may involve the Internet or any other suitable communications networks or paths (which is described in more detail in connection with FIG. 4). In addition, communications circuitry may include circuitry that enables peer-to-peer communication of user equipment devices, or communication of user equipment devices in locations remote from each other (described in more detail below).

Memory may be an electronic storage device provided as storage 308 that is part of control circuitry 304. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 3D disc recorders, digital video recorders (DVR, sometimes called a personal video recorder, or PVR), solid state devices, quantum storage devices, gaming consoles, gaming media, or any other suitable fixed or removable storage devices, and/or any combination of the same. Storage 308 may be used to store various types of content described herein as well as media guidance information, described above, and guidance application data, described above. Nonvolatile memory may also be used (e.g., to launch a boot-up routine and other instructions). Cloud-based storage, described in relation to FIG. 4, may be used to supplement storage 308 or instead of storage 308.

Control circuitry 304 may include video generating circuitry and tuning circuitry, such as one or more analog tuners, one or more MPEG-2 decoders or other digital decoding circuitry, high-definition tuners, or any other suitable tuning or video circuits or combinations of such circuits. Encoding circuitry (e.g., for converting over-the-air, analog, or digital signals to MPEG signals for storage) may also be provided. Control circuitry 304 may also include scaler circuitry for upconverting and downconverting content into the preferred output format of the user equipment 300. Circuitry 304 may also include digital-to-analog converter circuitry and analog-to-digital converter circuitry for converting between digital and analog signals. The tuning and encoding circuitry may be used by the user equipment device to receive and to display, to play, or to record content. The tuning and encoding circuitry may also be used to receive guidance data. The circuitry described herein, including for example, the tuning, video generating, encoding, decoding, encrypting, decrypting, scaler, and analog/digital circuitry, may be implemented using software running on one or more general purpose or specialized processors. Multiple tuners may be provided to handle simultaneous tuning functions (e.g., watch and record functions, picture-in-picture (PIP) functions, multiple-tuner recording, etc.). If storage 308 is provided as a separate device from user equipment 300, the tuning and encoding circuitry (including multiple tuners) may be associated with storage 308.

A user may send instructions to control circuitry 304 using user input interface 310. User input interface 310 may be any suitable user interface, such as a remote control, mouse, trackball, keypad, keyboard, touch screen, touchpad, stylus input, joystick, voice recognition interface, or other user input interfaces. Display 312 may be provided as a stand-alone device or integrated with other elements of user equipment device 300. Display 312 may be one or more of a monitor, a television, a liquid crystal display (LCD) for a mobile device, or any other suitable equipment for displaying visual images. In some embodiments, display 312 may be HDTV-capable. In some embodiments, display 312 may be a 3D display, and the interactive media guidance application and any suitable content may be displayed in 3D. A video card or graphics card may generate the output to the display 312. The video card may offer various functions such as accelerated rendering of 3D scenes and 2D graphics, MPEG-2/MPEG-4 decoding, TV output, or the ability to connect multiple monitors. The video card may be any processing circuitry described above in relation to control circuitry 304. The video card may be integrated with the control circuitry 304. Speakers 314 may be provided as integrated with other elements of user equipment device 300 or may be stand-alone units. The audio component of videos and other content displayed on display 312 may be played through speakers 314. In some embodiments, the audio may be distributed to a receiver (not shown), which processes and outputs the audio via speakers 314.

The guidance application may be implemented using any suitable architecture. For example, it may be a stand-alone application wholly implemented on user equipment device 300. In such an approach, instructions of the application are stored locally, and data for use by the application is downloaded on a periodic basis (e.g., from an out-of-band feed, from an Internet resource, or using another suitable approach). In some embodiments, the media guidance application is a client-server based application. Data for use by a thick or thin client implemented on user equipment device 300 is retrieved on-demand by issuing requests to a server remote to the user equipment device 300. In one example of a client-server based guidance application, control circuitry 304 runs a web browser that interprets web pages provided by a remote server.

In some embodiments, the media guidance application is downloaded and interpreted or otherwise run by an interpreter or virtual machine (run by control circuitry 304). In some embodiments, the guidance application may be encoded in the ETV Binary Interchange Format (EBIF), received by control circuitry 304 as part of a suitable feed, and interpreted by a user agent running on control circuitry 304. For example, the guidance application may be an EBIF application. In some embodiments, the guidance application may be defined by a series of JAVA-based files that are received and run by a local virtual machine or other suitable middleware executed by control circuitry 304. In some of such embodiments (e.g., those employing MPEG-2 or other digital media encoding schemes), the guidance application may be, for example, encoded and transmitted in an MPEG-2 object carousel with the MPEG audio and video packets of a program.

User equipment device 300 of FIG. 3 can be implemented in system 400 of FIG. 4 as user television equipment 402, user computer equipment 404, wireless user communications device 406, or any other type of user equipment suitable for accessing content, such as a non-portable gaming machine. For simplicity, these devices may be referred to herein collectively as user equipment or user equipment devices, and may be substantially similar to user equipment devices described above. User equipment devices, on which a media guidance application may be implemented, may function as a stand-alone device or may be part of a network of devices. Various network configurations of devices may be implemented and are discussed in more detail below.

A user equipment device utilizing at least some of the system features described above in connection with FIG. 3 may not be classified solely as user television equipment 402, user computer equipment 404, or a wireless user communications device 406. For example, user television equipment 402 may, like some user computer equipment 404, be Internet-enabled allowing for access to Internet content, while user computer equipment 404 may, like some television equipment 402, include a tuner allowing for access to television programming. The media guidance application may have the same layout on various different types of user equipment or may be tailored to the display capabilities of the user equipment. For example, on user computer equipment 404, the guidance application may be provided as a website accessed by a web browser. In another example, the guidance application may be scaled down for wireless user communications devices 406.

In system 400, there is typically more than one of each type of user equipment device but only one of each is shown in FIG. 4 to avoid overcomplicating the drawing. In addition, each user may utilize more than one type of user equipment device and also more than one of each type of user equipment device.

In some embodiments, a user equipment device (e.g., user television equipment 402, user computer equipment 404, wireless user communications device 406) may be referred to as a “second screen device.” For example, a second screen device may supplement content presented on a first user equipment device. The content presented on the second screen device may be any suitable content that supplements the content presented on the first device. In some embodiments, the second screen device provides an interface for adjusting settings and display preferences of the first device. In some embodiments, the second screen device is configured for interacting with other second screen devices or for interacting with a social network. The second screen device can be located in the same room as the first device, a different room from the first device but in the same house or building, or in a different building from the first device.

The user may also set various settings to maintain consistent media guidance application settings across in-home devices and remote devices. Settings include those described herein, as well as channel and program favorites, programming preferences that the guidance application utilizes to make programming recommendations, display preferences, and other desirable guidance settings. For example, if a user sets a channel as a favorite on, for example, the website www.allrovi.com on their personal computer at their office, the same channel would appear as a favorite on the user's in-home devices (e.g., user television equipment and user computer equipment) as well as the user's mobile devices, if desired. Therefore, changes made on one user equipment device can change the guidance experience on another user equipment device, regardless of whether they are the same or a different type of user equipment device. In addition, the changes made may be based on settings input by a user, as well as user activity monitored by the guidance application.

The user equipment devices may be coupled to communications network 414. Namely, user television equipment 402, user computer equipment 404, and wireless user communications device 406 are coupled to communications network 414 via communications paths 408, 410, and 412, respectively. Communications network 414 may be one or more networks including the Internet, a mobile phone network, mobile voice or data network (e.g., a 4G or LTE network), cable network, public switched telephone network, or other types of communications network or combinations of communications networks. Paths 408, 410, and 412 may separately or together include one or more communications paths, such as, a satellite path, a fiber-optic path, a cable path, a path that supports Internet communications (e.g., IPTV), free-space connections (e.g., for broadcast or other wireless signals), or any other suitable wired or wireless communications path or combination of such paths. Path 412 is drawn with dotted lines to indicate that in the exemplary embodiment shown in FIG. 4 it is a wireless path and paths 408 and 410 are drawn as solid lines to indicate they are wired paths (although these paths may be wireless paths, if desired). Communications with the user equipment devices may be provided by one or more of these communications paths, but are shown as a single path in FIG. 4 to avoid overcomplicating the drawing.

Although communications paths are not drawn between user equipment devices, these devices may communicate directly with each other via communication paths, such as those described above in connection with paths 408, 410, and 412, as well as other short-range point-to-point communication paths, such as USB cables, IEEE 1394 cables, wireless paths (e.g., Bluetooth, infrared, IEEE 802-11x, etc.), or other short-range communication via wired or wireless paths. BLUETOOTH is a certification mark owned by Bluetooth SIG, INC. The user equipment devices may also communicate with each other directly through an indirect path via communications network 414.

System 400 includes content source 416 and media guidance data source 418 coupled to communications network 414 via communication paths 420 and 422, respectively. Paths 420 and 422 may include any of the communication paths described above in connection with paths 408, 410, and 412. Communications with the content source 416 and media guidance data source 418 may be exchanged over one or more communications paths, but are shown as a single path in FIG. 4 to avoid overcomplicating the drawing. In addition, there may be more than one of each of content source 416 and media guidance data source 418, but only one of each is shown in FIG. 4 to avoid overcomplicating the drawing. (The different types of each of these sources are discussed below.) If desired, content source 416 and media guidance data source 418 may be integrated as one source device. Although communications between sources 416 and 418 with user equipment devices 402, 404, and 406 are shown as through communications network 414, in some embodiments, sources 416 and 418 may communicate directly with user equipment devices 402, 404, and 406 via communication paths (not shown) such as those described above in connection with paths 408, 410, and 412.

Content source 416 may include one or more types of content distribution equipment including a television distribution facility, cable system headend, satellite distribution facility, programming sources (e.g., television broadcasters, such as NBC, ABC, HBO, etc.), intermediate distribution facilities and/or servers, Internet providers, on-demand media servers, and other content providers. NBC is a trademark owned by the National Broadcasting Company, Inc., ABC is a trademark owned by the American Broadcasting Company, Inc., and HBO is a trademark owned by the Home Box Office, Inc. Content source 416 may be the originator of content (e.g., a television broadcaster, a Webcast provider, etc.) or may not be the originator of content (e.g., an on-demand content provider, an Internet provider of content of broadcast programs for downloading, etc.). Content source 416 may include cable sources, satellite providers, on-demand providers, Internet providers, over-the-top content providers, or other providers of content. Content source 416 may also include a remote media server used to store different types of content (including video content selected by a user), in a location remote from any of the user equipment devices. Systems and methods for remote storage of content, and providing remotely stored content to user equipment are discussed in greater detail in connection with Ellis et al., U.S. Pat. No. 7,761,892, issued Jul. 20, 2010, which is hereby incorporated by reference herein in its entirety.

Media guidance data source 418 may provide media guidance data, such as the media guidance data described above. Media guidance application data may be provided to the user equipment devices using any suitable approach. In some embodiments, the guidance application may be a stand-alone interactive television program guide that receives program guide data via a data feed (e.g., a continuous feed or trickle feed).

Program schedule data and other guidance data may be provided to the user equipment on a television channel sideband, using an in-band digital signal, using an out-of-band digital signal, or by any other suitable data transmission technique. Program schedule data and other media guidance data may be provided to user equipment on multiple analog or digital television channels.

In some embodiments, guidance data from media guidance data source 418 may be provided to users' equipment using a client-server approach. For example, a user equipment device may pull media guidance data from a server, or a server may push media guidance data to a user equipment device. In some embodiments, a guidance application client residing on the user's equipment may initiate sessions with source 418 to obtain guidance data when needed, e.g., when the guidance data is out of date or when the user equipment device receives a request from the user to receive data. Media guidance may be provided to the user equipment with any suitable frequency (e.g., continuously, daily, a user-specified period of time, a system-specified period of time, in response to a request from user equipment, etc.). Media guidance data source 418 may provide user equipment devices 402, 404, and 406 the media guidance application itself or software updates for the media guidance application.

Media guidance applications may be, for example, stand-alone applications implemented on user equipment devices. For example, the media guidance application may be implemented as software or a set of executable instructions which may be stored in storage 308, and executed by control circuitry 304 of a user equipment device 300. In some embodiments, media guidance applications may be client-server applications where only a client application resides on the user equipment device, and a server application resides on a remote server. For example, media guidance applications may be implemented partially as a client application on control circuitry 304 of user equipment device 300 and partially on a remote server as a server application (e.g., media guidance data source 418) running on control circuitry of the remote server. When executed by control circuitry of the remote server (such as media guidance data source 418), the media guidance application may instruct the control circuitry to generate the guidance application displays and transmit the generated displays to the user equipment devices. The server application may instruct the control circuitry of the media guidance data source 418 to transmit data for storage on the user equipment. The client application may instruct control circuitry of the receiving user equipment to generate the guidance application displays.

Content and/or media guidance data delivered to user equipment devices 402, 404, and 406 may be over-the-top (OTT) content. OTT content delivery allows Internet-enabled user devices, including any user equipment device described above, to receive content that is transferred over the Internet, including any content described above, in addition to content received over cable or satellite connections. OTT content is delivered via an Internet connection provided by an Internet service provider (ISP), but a third party distributes the content. The ISP may not be responsible for the viewing abilities, copyrights, or redistribution of the content, and may only transfer IP packets provided by the OTT content provider. Examples of OTT content providers include YOUTUBE, NETFLIX, and HULU, which provide audio and video via IP packets. YouTube is a trademark owned by Google Inc., Netflix is a trademark owned by Netflix Inc., and Hulu is a trademark owned by Hulu, LLC. OTT content providers may additionally or alternatively provide media guidance data described above. In addition to content and/or media guidance data, providers of OTT content can distribute media guidance applications (e.g., web-based applications or cloud-based applications), or the content can be displayed by media guidance applications stored on the user equipment device.

Media guidance system 400 is intended to illustrate a number of approaches, or network configurations, by which user equipment devices and sources of content and guidance data may communicate with each other for the purpose of accessing content and providing media guidance. The embodiments described herein may be applied in any one or a subset of these approaches, or in a system employing other approaches for delivering content and providing media guidance. The following four approaches provide specific illustrations of the generalized example of FIG. 4.

In one approach, user equipment devices may communicate with each other within a home network. User equipment devices can communicate with each other directly via short-range point-to-point communication schemes described above, via indirect paths through a hub or other similar device provided on a home network, or via communications network 414. Each of the multiple individuals in a single home may operate different user equipment devices on the home network. As a result, it may be desirable for various media guidance information or settings to be communicated between the different user equipment devices. For example, it may be desirable for users to maintain consistent media guidance application settings on different user equipment devices within a home network, as described in greater detail in Ellis et al., U.S. patent application Ser. No. 11/179,410, filed Jul. 11, 2005. Different types of user equipment devices in a home network may also communicate with each other to transmit content. For example, a user may transmit content from user computer equipment to a portable video player or portable music player.

In a second approach, users may have multiple types of user equipment by which they access content and obtain media guidance. For example, some users may have home networks that are accessed by in-home and mobile devices. Users may control in-home devices via a media guidance application implemented on a remote device. For example, users may access an online media guidance application on a website via a personal computer at their office, or a mobile device such as a PDA or web-enabled mobile telephone. The user may set various settings (e.g., recordings, reminders, or other settings) on the online guidance application to control the user's in-home equipment. The online guide may control the user's equipment directly, or by communicating with a media guidance application on the user's in-home equipment. Various systems and methods for user equipment devices communicating, where the user equipment devices are in locations remote from each other, is discussed in, for example, Ellis et al., U.S. Pat. No. 8,046,801, issued Oct. 25, 2011, which is hereby incorporated by reference herein in its entirety.

In a third approach, users of user equipment devices inside and outside a home can use their media guidance application to communicate directly with content source 416 to access content. Specifically, within a home, users of user television equipment 402 and user computer equipment 404 may access the media guidance application to navigate among and locate desirable content. Users may also access the media guidance application outside of the home using wireless user communications devices 406 to navigate among and locate desirable content.

In a fourth approach, user equipment devices may operate in a cloud computing environment to access cloud services. In a cloud computing environment, various types of computing services for content sharing, storage or distribution (e.g., video sharing sites or social networking sites) are provided by a collection of network-accessible computing and storage resources, referred to as “the cloud.” For example, the cloud can include a collection of server computing devices, which may be located centrally or at distributed locations, that provide cloud-based services to various types of users and devices connected via a network such as the Internet via communications network 414. These cloud resources may include one or more content sources 416 and one or more media guidance data sources 418. In addition or in the alternative, the remote computing sites may include other user equipment devices, such as user television equipment 402, user computer equipment 404, and wireless user communications device 406. For example, the other user equipment devices may provide access to a stored copy of a video or a streamed video. In such embodiments, user equipment devices may operate in a peer-to-peer manner without communicating with a central server.

The cloud provides access to services, such as content storage, content sharing, or social networking services, among other examples, as well as access to any content described above, for user equipment devices. Services can be provided in the cloud through cloud computing service providers, or through other providers of online services. For example, the cloud-based services can include a content storage service, a content sharing site, a social networking site, or other services via which user-sourced content is distributed for viewing by others on connected devices. These cloud-based services may allow a user equipment device to store content to the cloud and to receive content from the cloud rather than storing content locally and accessing locally-stored content.

A user may use various content capture devices, such as camcorders, digital cameras with video mode, audio recorders, mobile phones, and handheld computing devices, to record content. The user can upload content to a content storage service on the cloud either directly, for example, from user computer equipment 404 or wireless user communications device 406 having content capture feature. Alternatively, the user can first transfer the content to a user equipment device, such as user computer equipment 404. The user equipment device storing the content uploads the content to the cloud using a data transmission service on communications network 414. In some embodiments, the user equipment device itself is a cloud resource, and other user equipment devices can access the content directly from the user equipment device on which the user stored the content.

Cloud resources may be accessed by a user equipment device using, for example, a web browser, a media guidance application, a desktop application, a mobile application, and/or any combination of access applications of the same. The user equipment device may be a cloud client that relies on cloud computing for application delivery, or the user equipment device may have some functionality without access to cloud resources. For example, some applications running on the user equipment device may be cloud applications, i.e., applications delivered as a service over the Internet, while other applications may be stored and run on the user equipment device. In some embodiments, a user device may receive content from multiple cloud resources simultaneously. For example, a user device can stream audio from one cloud resource while downloading content from a second cloud resource. Or a user device can download content from multiple cloud resources for more efficient downloading. In some embodiments, user equipment devices can use cloud resources for processing operations such as the processing operations performed by processing circuitry described in relation to FIG. 3.

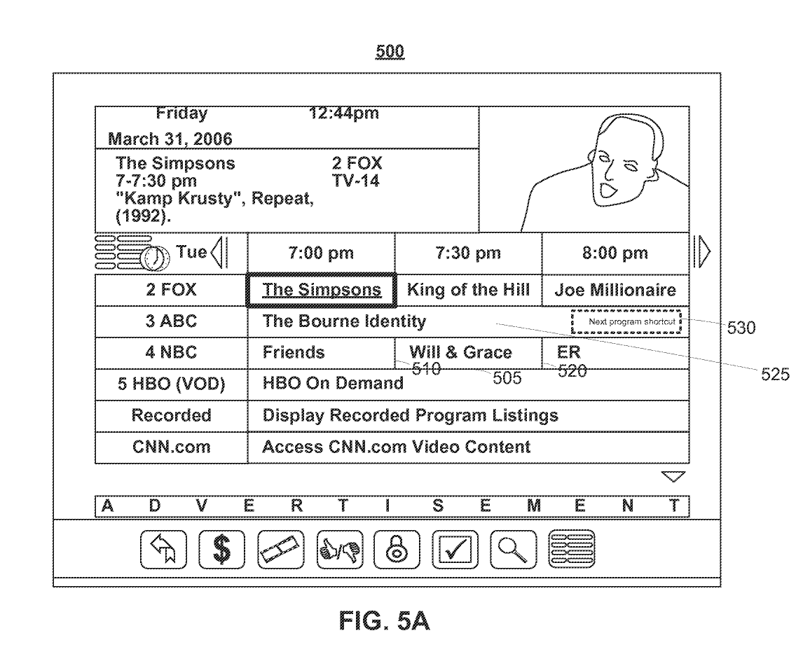

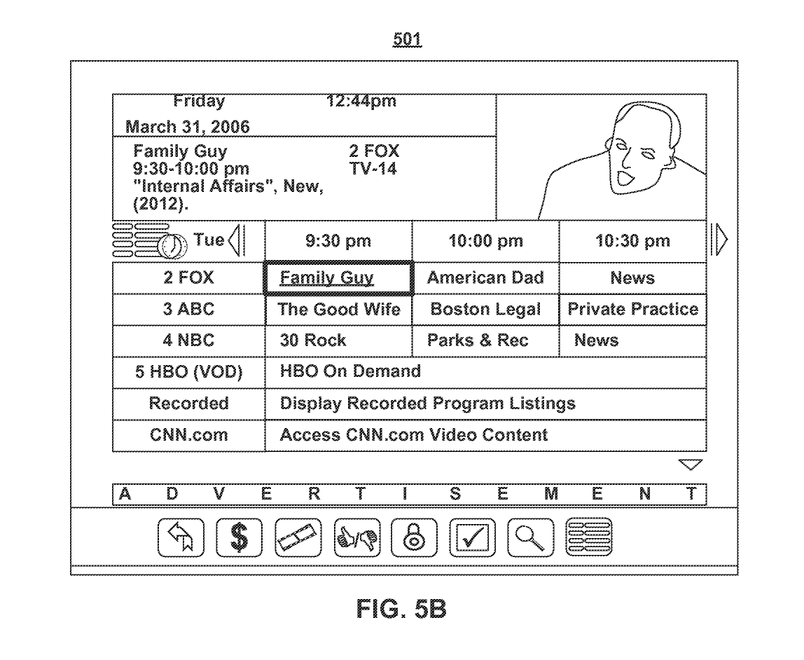

FIG. 5A shows an illustrative interactive media guidance application screen 500 demonstrating the functionality of shortcut buttons in accordance with some embodiments of the present disclosure. In certain embodiments, screen 500 may contain substantially similar information as display 100. The display of each program information cell in screen 500 is bounded by borders that represent a start time and an end time. For example, the display of program information cell 505 that is associated with the sitcom “Will and Grace” is bounded by border 510 representing a start time of 7:30 PM and border 520 representing the end time of 8 PM. In certain embodiments, these borders may be aligned with the cells of the time bar (i.e., the cells of the row of time identifiers 106).

Because screen 500 has a limited display area (i.e., the physical display on which screen 500 is rendered, such as display 312 integrated into user equipment device 300 (FIG. 3)), not all of the program information cells may be displayed in a single screen, and the entirety of each program information cell may not be displayed in a single screen. For example, as illustrated, program information cell 525 is associated with the movie “The Bourne Identity,” which has a start time of 7 PM and an end time of 9:30 PM. However, screen 500 cannot display all of program information cell 525 as the time bar only covers three intervals of time: 7 PM to 7:30 PM, 7:30 PM to 8 PM, and 8 PM to 8:30 PM. Accordingly, program information cell 525 is bounded by an end time that is not displayed in the time bar. As can be seen in screen 500, program information cell 525 contains only the title of the program, and as such has free space.

In certain embodiments, the guidance application may automatically determine which cells in screen 500 are bounded by an end time that is not displayed in the time bar. In certain embodiments, program information cells may be associated with a data structure that indicates the start time, end time, or both of the program associated with the program information cell. The times displayed in the time bar in a particular screen may then be compared to the end times in order to automatically determine which program information cells are bounded by end times that are not displayed in the time bar.

Program information cell 525 also includes shortcut button 530. Shortcut button 530 may be automatically rendered in a program information cell as a result of a determination that the program information cell 525 is bounded by an end time that is not displayed in the time bar of screen 500. Although program information cell 525 is the only cell that meets this criterion in the particular illustrated screen 500, it shall be understood that any number of the program information cells may be associated with end times that are not displayed in the time bar of the screen, and as a result also contain shortcut buttons.

In certain embodiments, shortcut button 530 may contain information associated with the next program that is presented (e.g., broadcast) on the same channel. This information may include program title, program start time, program duration, user rating, parental guidance rating, genre, actor information, director information, or presentation quality associated with the next program that is presented on the channel. For example, shortcut button 530 may contain the text “Next program at 9:30 PM” or “The Good Wife, 9:30 PM.” Such descriptive information may allow the user to quickly preview what is being presented next on a particular channel without having to scroll through the guide. In certain embodiments, this information may be guidance data that is retrieved from guidance data source 418 (FIG. 4).

In certain embodiments, shortcut button 530 may be selectable. For example, a user may press the area on the screen of a tablet where shortcut button 530 is displayed, press buttons on a remote control to navigate a highlight region to shortcut button 530, or use any other suitable method of input provided by a user input interface 310 to select shortcut button 530.

FIG. 5B shows illustrative interactive media guidance application screen 501 after selection of shortcut button 530 in accordance with some embodiments of the present disclosure. As illustrated, the media guidance application automatically generates the program grid in screen 501 by translating the rendering of the program grid along the horizontal time axis as compared to the program grid illustrated in screen 500. In other words, the program grid has advanced one hour in time to display listings for the periods of time after the end time of the program information cell whose shortcut button was selected. For example, in screen 501 the leftmost time cell in the time bar is associated with a 9:30 to 10 PM time slot, which is directly after the 9:30 PM end time of the program associated with program information cell 525 (FIG. 5A). In this manner, a user who is browsing the program information cells can select the shortcut button rather than executing multiple scroll gestures or button presses in order to navigate to the listings after a long program. In the particular example illustrated in FIGS. 5A and 5B, the user is saved two scroll gestures or button presses in order to navigate to the listings in screen 501 from screen 500, as “The Good Wife” does not start until one hour after the 8:30 PM cutoff of the program cells displayed in screen 500. In certain embodiments, a transition may be displayed between the display of screen 500 and screen 501 such that the program grid appears to be scrolling in a smooth motion. In certain embodiments, screen 501 may appear immediately after selection of shortcut button 530 without any transition in between.

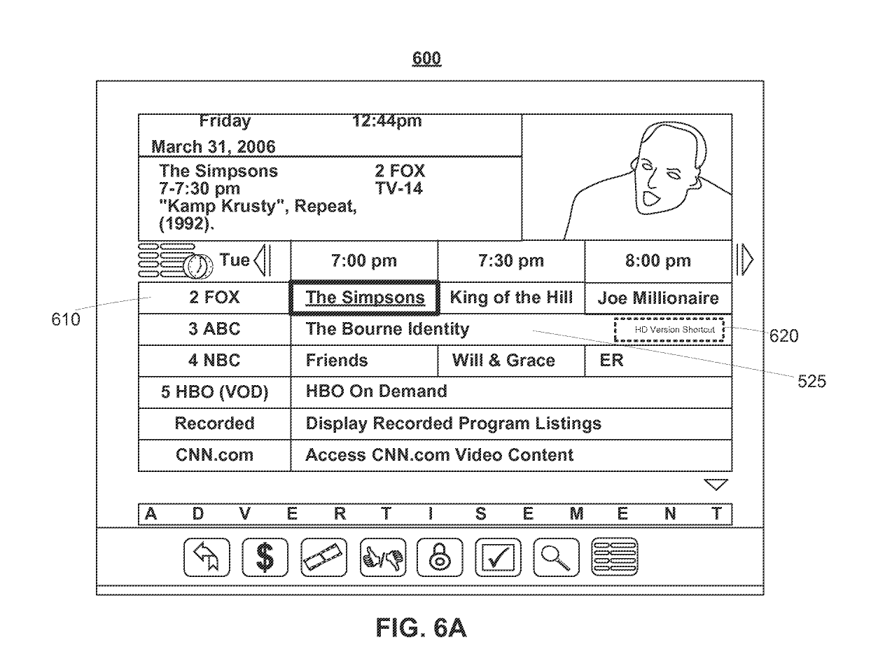

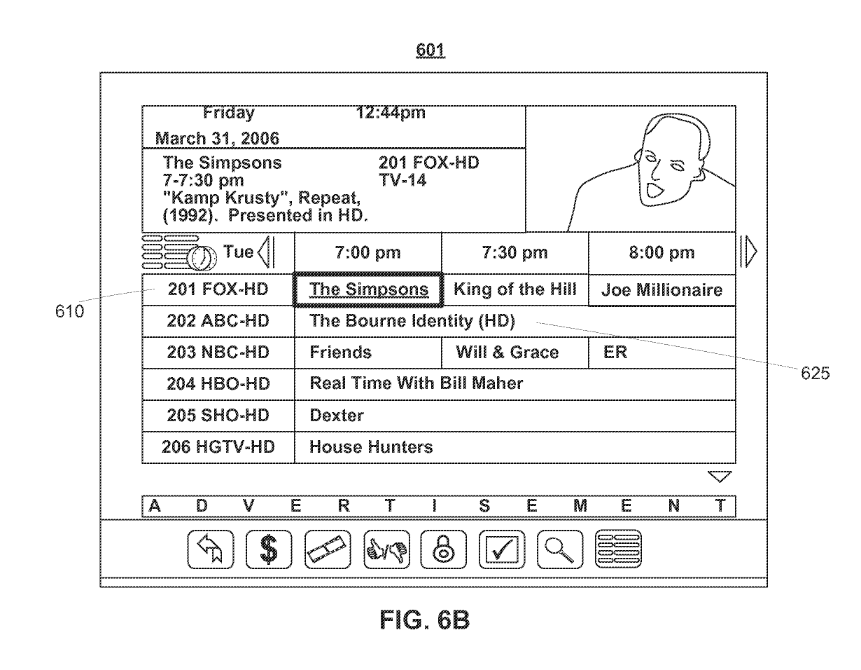

FIG. 6A shows an illustrative interactive media guidance application screen 600 demonstrating the functionality of shortcut buttons in accordance with some embodiments of the present disclosure. In certain embodiments, screen 600 may contain channel/content type identifiers 610 that are substantially similar to channel/content type identifiers 610. In certain embodiments, channel/content type identifiers 610 may be associated with the presentation of standard-definition content. For example, a cable provider may provide a subscriber access to a channel that broadcasts standard-definition versions of programs associated with a network and another channel that broadcasts high-definition versions of the same programs associated with the same network. For example, as illustrated, channel/content type identifiers 610 are associated with the presentation of standard-definition content.

Because screen 600 often contains channel/content type identifiers 610 for a limited amount of channels, it may not be possible to view the channels containing high-definition content on the same screen as their standard-definition counterparts. Further, a user may wish to easily navigate between a standard-definition channel and a high-definition channel in order to watch, record, or set a reminder to watch the high-definition content in lieu of standard definition content. Accordingly, in certain embodiments, shortcut buttons may be placed in program information cells associated with standard-definition content that, when selected, cause the media guidance application to automatically translate the rendering of the program grid to a portion of the guide containing a program information cell associated with corresponding high-definition content.

For example, as illustrated, program information cell 525 is associated with the standard-definition presentation of the movie “The Bourne Identity.” In certain embodiments, the guidance application may automatically determine which cells in screen 600 are associated with standard definition content and have high-definition counterparts. In certain embodiments, program information cells may be associated with a data structure that indicates the presentation quality of the program, as well as the program title. This information may be searched in order to determine high-definition counterparts of program cells associated with standard definition content. As a result, shortcut button 620 may be placed in program cells associated with the presentation of standard-definition content that allow the user to quickly navigate to the high-definition counterpart.

In certain embodiments, shortcut button 620 may contain information associated with the high-definition version of the program. For example, shortcut button 620 may contain the text “High definition counterpart available on channel 502”.

FIG. 6B shows an illustrative interactive media guidance application screen 601 after selection of shortcut button 620 in accordance of some embodiments of the present disclosure. As illustrated, the media guidance application automatically generates the program grid in screen 601 by translating the rendering of the program grid along the vertical channel/content axis, but not the horizontal time axis, as compared to the program grid illustrated in screen 600. As shown by channel/content type identifiers 610, the channel cells are associated with the presentation of high-definition content. Further, the screen of program information cells include high-definition counterpart cell 625, which is the high-definition counterpart of program information cell 525. In certain embodiments, high-definition counterpart cell may be associated with the same channel as its standard-definition counterpart. In other embodiments, the high-definition counterpart cell may be associated with a different channel than the standard-definition counterpart.

In certain embodiments (not shown), shortcut buttons may be placed in program cells associated with the presentation of high-definition content that allow a user to quickly navigate to corresponding standard-definition content. The determination of placement and functionality of these shortcut buttons may be substantially similar to that discussed with respect to shortcut button 620 above.

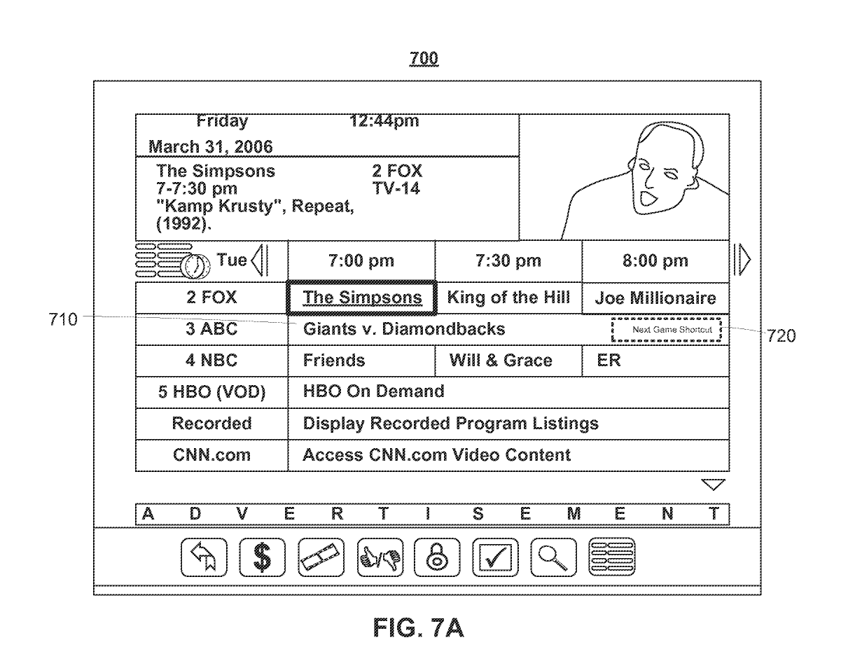

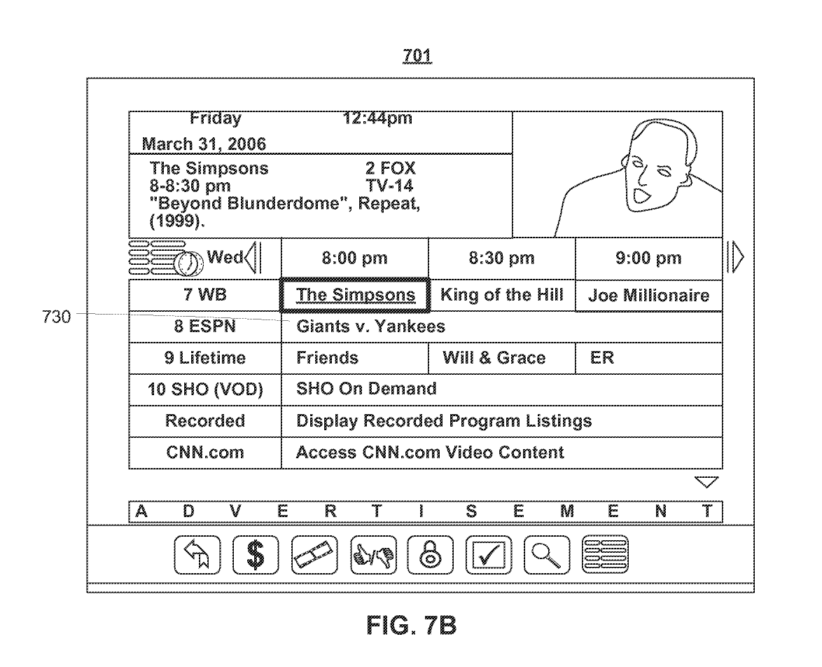

FIG. 7A shows an illustrative interactive media guidance application screen 700 demonstrating the functionality of shortcut buttons in accordance with some embodiments of the present disclosure. In certain embodiments, screen 700 may include sports program information cell 710. Sports program information cell 710 may be associated with a sporting event featuring one or more sports teams. For example, as illustrated sports program information cell is associated with a baseball game between the San Francisco Giants and the Arizona Diamondbacks. Because screen 700 often contains a limited amount of program information cells associated with a limited range of channel/content type identifiers and time identifiers for a limited number of periods of time, it may not be possible to view listings of subsequent games played by a particular sports game within the same screen. Further, a user may want to easily navigate between games played by a particular sports team that are broadcast across different channels on erratic schedules. Accordingly, in certain embodiments, shortcut buttons may be placed in program information cells associated with a subsequent sporting event featuring a same sports team.

In certain embodiments, the guidance application may automatically determine which program information cells in screen 700 are associated with a sporting event featuring a particular sports team that is playing a subsequent sporting event. The program guidance application may also determine another program information cell associated with the subsequent sporting event. In certain embodiments, program information cells may be associated with a data structure that indicates the one or more sports team playing in the sporting event associated with the respective program information cell. This information may be searched in order to determine the program information cell associated with the subsequent sporting event. As a result of these determinations, shortcut button 720 may be placed in program cells associated with a sporting event featuring a particular sports team.

In certain embodiments, shortcut button 720 may contain information associated with the subsequent sporting event. For example, shortcut button 720 may contain the text “Giants next game at 8 PM Wednesday”.

FIG. 7B shows an illustrative interactive media guidance application screen 701 after selection of shortcut button 720 in accordance with some embodiments of the present disclosure. As illustrated, the media guidance application automatically generates the program grid in screen 701 by translating the rendering of the program grid along both the vertical channel/content axis as well as the horizontal time axis as compared to the program grid illustrated in screen 700. As shown, the program grid in screen 701 contains subsequent sporting event program information cell 730. Subsequent sporting event program information cell 730 is associated with a sporting event featuring a particular sports team that is also associated with the program information cell in which the selected shortcut button 720 was displayed. In certain embodiments, subsequent sporting event program information cell 730 is associated with the same channel as the program information cell in which the selected shortcut button 720 was displayed. In other embodiments, the subsequent sporting event program information cell 730 is associated with a different channel than the program information cell in which the selected shortcut button 720 was displayed.

In certain embodiments (not shown), shortcut buttons may be placed in program information cells associated with episodes of programs that appear in a series. For example, a shortcut button may be placed in a program information cell associated with an episode of the series “24”. In certain embodiments, the guidance application may automatically determine which cells in a screen of program information cells (e.g., screens 500, 600, or 700) are associated with a series program, and determine program information cells associated with subsequent episodes of the series program (i.e., an episode of a series program that is later in the season). In certain embodiments, program information cells may be associated with a data structure that indicates the series name and series episode number of the program. This information may be searched in order to determine program information cells associated with subsequent episodes of a series program. When a shortcut button is selected, the media guidance application may automatically translate the rendering of the program grid to a portion that contains a subsequent episode of the same series associated with the program information cell in which the shortcut button was displayed.

In certain embodiments (not shown), shortcut buttons may be placed in program information cells associated with episodes of a favorite show of the user that are presented (i.e., aired) after the program that the user is currently watching ends. For example, a shortcut button may be placed in a program information cell that indicates that an episode of a show that the user frequently watches is airing in a time slot after the program that they are currently watching is finished. In certain embodiments, the guidance application may automatically determine a program information cell associated with an episode of a favorite show of a user airing after the program that user is currently watching. In certain embodiments, this determination may be made by searching data associated with the program information cells using any suitable user profile information. When a shortcut button is selected, the media guidance application may automatically translate the rendering of the program grid to a portion that contains an episode of the user's favorite show.

In certain embodiments, a user may enter information in the guidance application using any suitable user input interface 314 (FIG. 3) that specifies the frequency that shortcut buttons will be displayed in the program guide. For example, a user may specify that they only wish to see a particular number of shortcut buttons displayed in a single screen of the grid guide. In certain embodiments, this information may be stored in a user profile. In this manner, the display of the shortcut buttons described with respect to FIGS. 5A, 6A, and 7A may be limited.

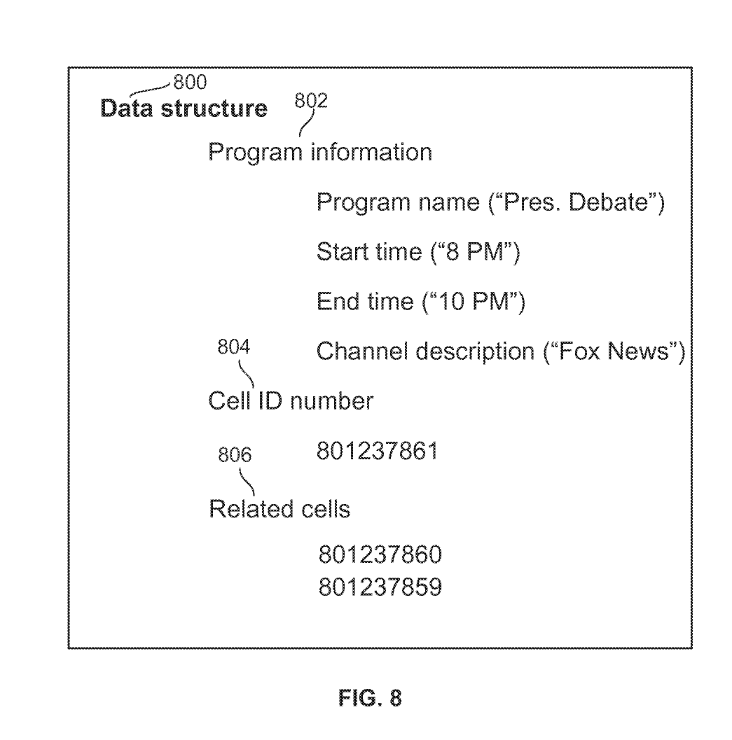

FIG. 8 shows an illustrative data structure 800 associated with a program information cell in a program grid in accordance with some embodiments of the present disclosure. The program information cell may be similar to any of the program information cells discussed with respect to FIGS. 5A, 5B, 6A, 6B, 7A, and 7B. The program grid may be similar to that illustrated in screens 500, 501, 600, 601, 700, and 701. As illustrated, data structure 800 may contain program information 802. Program information 802 may include one or more of a program name associated with the program information cell, a start time associated with the program associated with the program information cell, an end time associated with the program associated with the program information cell, a channel number or channel description (e.g., “FOX News” or “CBS”), a sports team name (e.g., “San Francisco Giants”), a presentation quality (e.g., “standard-definition” or “high-definition”), a series name (e.g., “24”), and a series episode number (e.g., “Season 4, Episode 2”). In certain embodiments, data structure 800 may also include cell ID number 804. Cell ID number 804 may include a unique identification number. This number may be used to reference the program information cell in, for example, related cell field 806. Related cell field 806 may include one or more cell ID numbers that indicate program information cells that are related to the program information cell associated with data structure 800. These related program information cells may be determined substantially similar to the determinations discussed with respect to FIGS. 5A, 5B, 6A, 6B, 7A, and 7B.

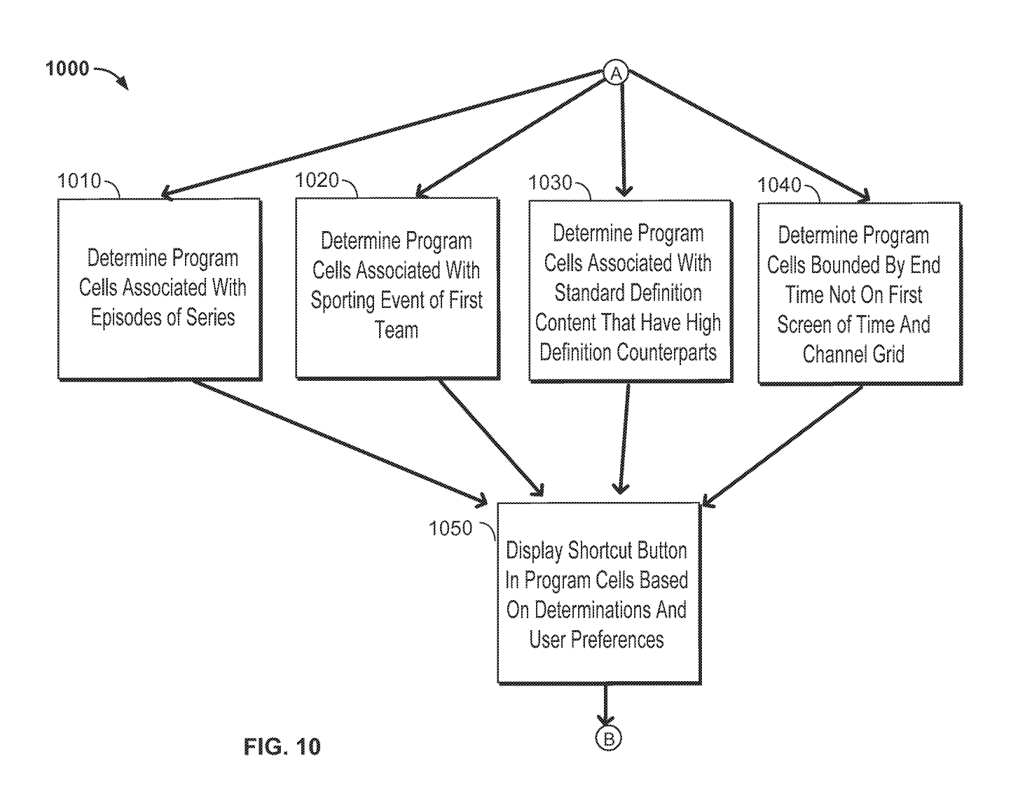

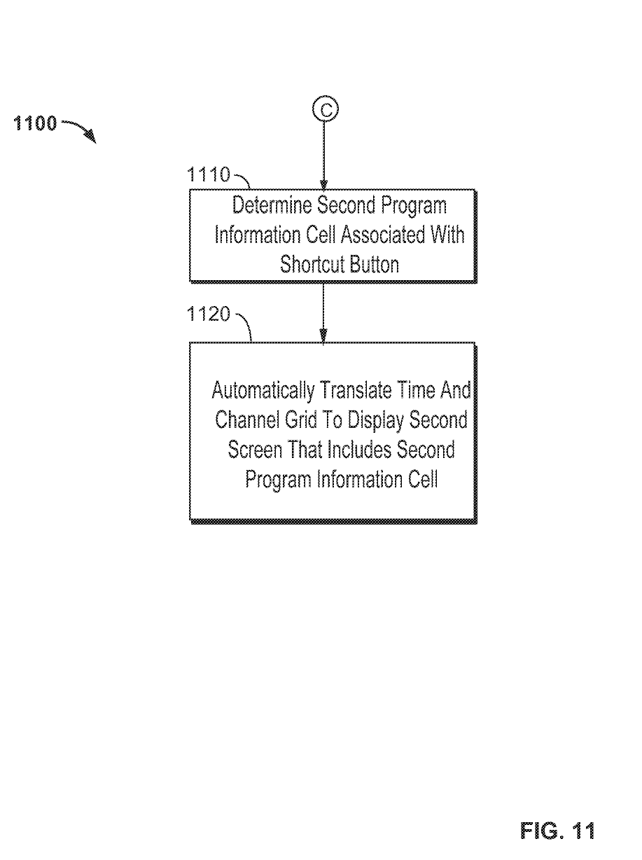

FIG. 9 shows an illustrative flowchart of a process 900 for presenting shortcuts in free spaces of a program guide in accordance with some embodiments of the present disclosure. Process 900 may be executed on any suitable user equipment as part of a guidance application, such as user equipment 300 (FIG. 3). Process 900 begins at step 910. At step 910, program cells may be displayed in a first screen of a time and channel grid. This time and channel grid may be substantially similar to that illustrated with respect to screens 500, 600, and 700. Process 900 proceeds to step 920. At step 920, program information cells in which to place or display program shortcut buttons are determined. These determinations may be made as discussed with respect to process 1000 (FIG. 10) below. In some embodiments, these placements may be determined by making automatic determinations using characteristics or data associated with the program information cells, such as the data discussed with respect to data structure 800 (FIG. 8). In some embodiments, this data may be retrieved from media guidance data source 418 (FIG. 4). Process 900 then proceeds to step 930.

At step 930, shortcut buttons are displayed in the program cells. The display of these shortcut buttons may be similar to the shortcut buttons discussed with respect to screens 500, 600, and 700. Process 900 proceeds to step 940. At step 940, a user may select a shortcut button. This selection may be achieved using any suitable user input interface 314 (FIG. 3). For example, a user may execute a touch gesture on a touch screen or select a button on a remote control in order to select the shortcut buttons. Process 900 proceeds to step 950. At step 950, the time and channel grid may be automatically translated along the time axis, channel/content axis, or both based on the selected shortcut button to display a second screen of the time and channel grid. This translation may be achieved by the media guidance application automatically translating the rendering of the program grid. This second screen of the time and channel grid may contain a program information cell determined to be related to the program information cell in which the shortcut button was displayed. For example, the second screen may be substantially similar to screens 501, 601, and 701. Process 900 then ends. These related program information cells may be determined as discussed with respect to process 1100 (FIG. 11) discussed below.

FIG. 10 shows an illustrative flowchart of a process 1000 for presenting shortcuts in free spaces of a program guide in accordance with some embodiments of the present disclosure. Process 1000 may be executed on any suitable user equipment as part of a guidance application, such as user equipment 300 (FIG. 3). Process 1000 may start by executing one or more of steps 1010, 1020, 1030, and 1040. At step 1010, program cells bounded by an end time not displayed in the time bar of the first screen of the time and channel grid are determined. This determination may be made by comparing data associated with the program information cells that convey the end time of the program against the time associated with the rightmost time cell in the program grid (e.g., 8 PM in the time bar displayed in the program grid in screen 500 (FIG. 5A)). In certain embodiments, this data may be similar to program information 802 discussed with respect to data structure 800 (FIG. 8). Process 1000 may then proceed to step 1050. At step 1050, shortcut buttons may be displayed in the determined program cells. In certain embodiments, information may be displayed in the shortcut buttons as described with respect to shortcut button 530 (FIG. 5A). In certain embodiments, information may be linked to the shortcut buttons associated with a program information cell that conveys the time cell after the end time of the program information cell in which each respective shortcut button was displayed. This information may be substantially similar to related cell field 806 (FIG. 8). Process 1000 then ends.

At step 1020, program cells that are associated with standard definition content that have high definition counterparts are determined. These determinations may be made by comparing data associated with the program information cells that convey the title of the program and whether the program is presented in standard-definition or high-definition with similar data associated with other program information cells. Process 1000 may then proceed to step 1050. At step 1050, shortcut buttons may be displayed in the determined program information cells. In certain embodiments, information may be displayed in the shortcut buttons as described with respect to shortcut button 620 (FIG. 6A). In certain embodiments, information may be linked to the shortcut buttons associated with a program information cell that conveys a high-definition counterpart of the program associated with the program information cell in which the shortcut button was displayed. This information may be substantially similar to related cell field 806 (FIG. 8). Process 1000 then ends.

At step 1030, program cells that are associated with a sporting event featuring a first sports team are determined. These determinations may be made by comparing data associated with the program information cells that convey the title of the program and the sports team with similar data associated with other program information cells. In certain embodiments, this data may be similar to program information 802 discussed with respect to data structure 800 (FIG. 8). Process 1000 may then proceed to step 1050. At step 1050, shortcut buttons may be displayed in the determined program information cells. In certain embodiments, information may be displayed in the shortcut buttons as described with respect to shortcut button 720 (FIG. 7A). In certain embodiments, information may be linked to the shortcut buttons associated with a program information cell that conveys the next sporting event that features the first sports team associated with the program information cell in which the shortcut button was displayed. This information may be substantially similar to related cell field 806 (FIG. 8). Process 1000 then ends.

At step 1040, program information cells that are associated with episodes of a series are determined. These determinations may be made by comparing data associated with the program information cells that convey the title of the program, name of the series, and series episode number with similar data associated with other program cells. In certain embodiments, this data may be similar to program information 802 discussed with respect to data structure 800 (FIG. 8). Process 1000 may then proceed to step 1050. At step 1050, shortcut buttons may be displayed in the determined program information cells. In certain embodiments, information may be linked to the shortcut buttons associated with a program information cell that conveys the subsequent episode of the series associated with the program information cell in which the shortcut button was displayed. This information may be substantially similar to related cell field 806 (FIG. 8). Process 1000 then ends.

In some embodiments, the display of the shortcut buttons in step 1050 may be based on user preferences. For example, a user may enter information in the guidance application using any suitable user input interface 314 (FIG. 3) that specifies the frequency that shortcut buttons will be displayed in the program guide. In certain embodiments, this information may be stored in a user profile when it is entered by the user, and then accessed by the guidance application at step 1050. The accessed user preferences may then by used to limit the display of the shortcut buttons in various program screens.

FIG. 11 shows an illustrative flowchart of a process 1100 for presenting shortcuts in free spaces of a program guide in accordance with some embodiments of the present disclosure. Process 1100 may be executed on any suitable user equipment as part of a guidance application, such as user equipment 300 (FIG. 3). Process 1100 begins at step 1110. At step 1110, second program information cells may be determined that are associated with or related to the program information cell containing the shortcut button. These determinations may be made substantially similar to those discussed with respect to steps 1010, 1020, 1030, and 1040 of process 1000 (FIG. 10). Process 1100 proceeds to step 1120. At step 1120, the time and channel grid is automatically translated to display a second screen that includes the second program information cell. In certain embodiments, this automatic translation may be achieved by the media guidance application automatically translating the rendering of the program grid. These translations may be executed substantially similar to those discussed with respect to screens 501, 601, and 701 with respect to FIGS. 5B, 6B, and 7B, respectively. Process 1100 then ends.

It will be apparent to those of ordinary skill in the art that methods, techniques, and processes involved in the present disclosure may be embodied in a computer program product that includes a non-transitory computer usable and/or readable medium. For example, such a non-transitory computer readable medium may consist of a read-only memory device, such as a CD-ROM disk or conventional ROM devices, or a random access memory, such as a hard drive device or a computer diskette, having a computer readable program code stored thereon.

It is to be understood that while certain forms of the present disclosure have been illustrated and described herein, it is not to be limited to the specific forms or arrangement of parts described and shown. Those skilled in the art will know or be able to ascertain using no more than routine experimentation, many equivalents to the embodiments and practices described herein. Accordingly, it will be understood that the invention is not to be limited to the embodiments disclosed herein, which are presented for purposes of illustration and not of limitation.

1. A method for navigating media guidance information in a program guide, the method comprising:
causing a first screen of the program guide to be presented to a user, the first screen comprising:
a time bar divided into time cells, wherein each of the time cells represents an interval of time;
a content source identifier divided into channel cells, and
a program grid having program information cells for presenting information associated with media assets, wherein each of the program information cells is bounded by a start time and an end time, and the end time of at least one of the program information cells is not contained in the time bar; and
at least one shortcut button within the at least one of the program information cells for which the end time is not contained in the time bar;
receiving a user selection of one of the at least one shortcut buttons;
in response to the user selection of the one of the at least one shortcut buttons, determining the end time of the program information cell containing the selected shortcut button; and
automatically advancing the program grid causing a second screen of the program guide to be presented to the user, wherein each of the program information cells in the second screen is associated with a time cell immediately after the determined end time of the program information cell containing the selected shortcut button.

2. The method of claim 1, wherein the time bar is divided into time cells along a first axis, the content source identifier is divided into channel cells along a second axis, and the program guide is automatically advanced along the first axis by more than the interval of time.

3. The method of claim 1, wherein causing the first screen of the program guide to be presented to the user further comprises:
automatically determining a subset of the program information cells in the first screen for which the end time is not contained in the time bar of the first screen of the program guide; and
in response to the determination, causing the at least one shortcut button to be presented within each of the program information cells in the subset.

4. The method of claim 1, further comprising:
retrieving the information associated with a given program information cell for which the start time is substantially equal to the end time of the at least one of the program information cells for which the end time is not contained in the time bar; and
causing the information to be presented to the user via the at least one shortcut button within the at least one of the program information cells for which the end time is not contained in the time bar.

5. The method of claim 1, wherein the information comprises one or more of a program title, a program start time, a user rating, a parental guidance rating, a genre, an actor, and a director.

6. The method of claim 1, wherein the time bar is divided into time cells along a first axis, the content source identifier is divided into channel cells along a second axis, further comprising:
automatically determining a first program information cell in the first screen that is associated with standard definition content and has a high-definition counterpart;
automatically determining a second program information cell that is associated with the high-definition counterpart;
in response to the determinations, causing the at least one shortcut button to be presented to the user within the first program information cell;
receiving the user selection of the at least one shortcut button within the first program information cell; and
in response to the selection of the at least one shortcut button within the first program information cell, automatically translating the program grid across one or more of the first axis and the second axis causing a third screen of the program guide to be presented to the user that contains at least a portion of the second program information cell.

7. The method of claim 1, wherein the time bar is divided into time cells along a first axis, the content source identifier is divided into channel cells along a second axis, further comprising:
automatically determining a first program information cell in the first screen that is associated with a sporting event featuring a first sports team;
automatically determining a second program information cell that is associated with a subsequent sporting event featuring the first sports team; and
in response to the determinations, causing the at least one shortcut button to be presented to the user within the first program information cell;
receiving the user selection of the at least one shortcut button within the first program information cell; and
in response to the user selection of the shortcut button within the first program information cell, automatically translating the program grid across one or more of the first axis and the second axis causing a third screen of the program information guide to be presented to the user that contains at least a portion of the second program information cell.

8. The method of claim 1, wherein the time bar is divided into time cells along a first axis, the content source identifier is divided into channel cells along a second axis, further comprising:
automatically determining a first program information cell in the first screen that is associated with an episode of a series program;
automatically determining a second program information cell that is associated with a subsequent episode of the series program; and
in response to the determinations, causing the at least one shortcut button to be presented to the user within the first program information cell;
receiving the user selection of the shortcut button within the first program information cell; and
in response to the selection of the shortcut button within the first program information cell, automatically translating the program grid across one or more of the first axis and the second axis causing a third screen of the program information guide to be presented to the user that contains at least a portion of the second program information cell.

9. The method of claim 1, wherein the time bar is divided into time cells along a first axis, the content source identifier is divided into channel cells along a second axis, further comprising:
accessing user profile information that indicates a favorite show;
determining a first program information cell that is associated with an episode of the favorite show airing after a program that the user is currently watching;
in response to the determination, causing the at least one shortcut button to be presented to the user in a second program information cell associated with a program the user is currently watching;
receiving the user selection of the shortcut button within the second program information cell; and
in response to the selection of the shortcut button within the second program information cell, automatically translating the program grid across one or more of the first axis and the second axis causing a third screen of the program information guide to be presented to the user that contains at least a portion of the first program information cell.

10. The method of claim 9, further comprising:
accessing user profile information that indicates a shortcut button frequency; and
based on the shortcut button frequency, limiting the presentation to the user of the at least one shortcut button in the second program information cell associated with the program that the user is currently watching.

11. A system for navigating media guidance information in a program guide, the system comprising user equipment configured to:
generate for display a first screen of the program guide to a user, the first screen comprising:
a time bar divided into time cells, wherein each of the time cells represents an interval of time;
a content source identifier divided into channel cells, and
a program grid having program information cells for presenting information associated with media assets, wherein each of the program information cells is bounded by a start time and an end time, and the end time of at least one of the program information cells is not contained in the time bar; and
at least one shortcut button within the at least one of the program information cells for which the end time is not contained in the time bar;
receive a user selection of one of the at least one shortcut buttons using a user input interface;
in response to the user selection of the one of the at least one shortcut buttons, determine the end time of the program information cell containing the selected shortcut button; and
automatically advance the display of the program grid such that a second screen of the program guide is generated for display, wherein each of the program information cells in the second screen is associated with a time cell immediately after the determined end time of the program information cell containing the selected shortcut button.

12. The system of claim 11, wherein the time bar is divided into time cells along a first axis, the content source identifier is divided into channel cells along a second axis, and the program guide is automatically advanced along the first axis by more than the interval of time.

13. The system of claim 11, wherein the user equipment device is further configured to:
automatically determine a subset of the program information cells in the first screen for which the end time is not contained in the time bar of the first screen of the program guide; and
in response to the determination, generate for display the at least one shortcut button within each of the program information cells in the subset.

14. The system of claim 11, wherein the user equipment device is further configured to:
retrieve the information associated with a given program information cell for which the start time is substantially equal to the end time of the at least one of the program information cells for which the end time is not contained in the time bar; and
generate for display the information via the at least one shortcut button within the at least one of the program information cells for which the end time is not contained in the time bar.

15. The system of claim 11, wherein the information comprises one or more of a program title, a program start time, a user rating, a parental guidance rating, a genre, an actor, and a director.

16. The system of claim 11, wherein the time bar is divided into time cells along a first axis, the content source identifier is divided into channel cells along a second axis, and the user equipment device is further configured to:
automatically determine a first program information cell in the first screen that is associated with standard definition content and has a high-definition counterpart;
automatically determine a second program information cell that is associated with the high-definition counterpart;
in response to the determinations, generate for display the at least one shortcut button within the first program information cell;
receive the user selection of the at least one shortcut button within the first program information cell; and
in response to the selection of the at least one shortcut button within the first program information cell, automatically translate the program grid across one or more of the first axis and the second axis such that a third screen of the program guide is generated for display that contains at least a portion of the second program information cell.

17. The system of claim 11, wherein the time bar is divided into time cells along a first axis, the content source identifier is divided into channel cells along a second axis, and the user equipment device is further configured to:
automatically determine a first program information cell in the first screen that is associated with a sporting event featuring a first sports team;
automatically determine a second program information cell that is associated with a subsequent sporting event featuring the first sports team; and
in response to the determinations, generate for display the at least one shortcut button within the first program information cell;
receive the user selection of the at least one shortcut button within the first program information cell; and
in response to the user selection of the shortcut button within the first program information cell, automatically translate the program grid across one or more of the first axis and the second axis such that a third screen of the program information guide is generated for display that contains at least a portion of the second program information cell.

18. The system of claim 11, wherein the time bar is divided into time cells along a first axis, the content source identifier is divided into channel cells along a second axis, and the user equipment device is further configured to:
automatically determine a first program information cell in the first screen that is associated with an episode of a series program;
automatically determine a second program information cell that is associated with a subsequent episode of the series program; and
in response to the determinations, generate for display the at least one shortcut button within the first program information cell;
receive the user selection of the shortcut button within the first program information cell; and
in response to the selection of the shortcut button within the first program information cell, automatically translate the program grid across one or more of the first axis and the second axis such that a third screen of the program information guide is generated for display that contains at least a portion of the second program information cell.

19. The system of claim 11, wherein the time bar is divided into time cells along a first axis, the content source identifier is divided into channel cells along a second axis, and the user equipment device is further configured to:
access user profile information that indicates a favorite show;
determine a first program information cell that is associated with an episode of the favorite show airing after a program that the user is currently watching;
in response to the determination, generate for display the at least one shortcut button in a second program information cell associated with a program the user is currently watching;
receive the user selection of the shortcut button within the second program information cell; and
in response to the selection of the shortcut button within the second program information cell, automatically translate the program grid across one or more of the first axis and the second axis such that a third screen of the program information guide is generated for display that contains at least a portion of the first program information cell.

20. The system of claim 19, wherein the user equipment device is further configured to:
access user profile information that indicates a shortcut button frequency; and
based on the shortcut button frequency, limit the generation for display of the at least one shortcut button in the second program information cell associated with the program that the user is currently watching.

21-30. (canceled)
